(19) United States
(12) Patent Application Publication
(10) Pub. No.: US 2006/0160533 A1
(43) Pub. Date: Jul. 20, 2006

(54) Method and system of network management and service provisioning for mobile broadband wireless networks

(76) Inventors: Joey Chou, Scottsdale, AZ (US); Shlomo Ovadia, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/039,400

(22) Filed: Jan. 19, 2005

(51) Int. Cl. H04Q 7/20

(52) U.S. Cl. 455/422.1

(57) ABSTRACT

A method and system for network management and service provisioning for mobile broadband wireless networks. The method and system employ a network management system (NMS) to manage nodes corresponding to base stations (BS) and mobile subscriber stations (MSS). A service flow database is used to store data relating to pre-provisioned dynamic service flows for subscribers having service agreements with a service provider for the mobile broadband wireless network. Management Information Bases (MIBs) are hosted by the various BSs in the network. The MIBs contain tabulated data that is used to define and provision dynamic service flows. The MIBs are structured to enable management of the MIBs via Simple Network Management Protocol (SNMP) messaging and SNMP agents operating on SNMP managed nodes for the BSs. Hand-over methods are also supported that forward service flow information between a serving BS and a target BS to pre-provision service flows at the target BS.

### FIELD OF THE INVENTION

The field of invention relates generally to wireless communication networks and, more specifically but not exclusively relates to a method and system for fast hand-over of mobile subscriber stations in broadband wireless networks.

### BACKGROUND INFORMATION

IEEE (Institute of Electrical and Electronic Engineers) 802.16 is an emerging suite of air interface standards for combined fixed, portable and Mobile Broadband Wireless Access (MBWA). Initially conceived as a radio standard to enable cost-effective last-mile broadband connectivity to those not served by wired broadband such as cable or DSL, the specifications are evolving to target a broader market opportunity for mobile, high-speed broadband applications. The IEEE 802.16 architecture not only addresses the traditional “last mile” problem, but also supports nomadic and mobile clients on the go. The MBWA architecture is being standardized by the Worldwide Interoperability for Microwave Access (WiMAX) forum Network Working Group (NWG). For convenience, the terms 802.16 and WiMAX are used interchangeably throughout this specification to refer to the IEEE 802.16 suite of air interface standards.

FIG. 1 shows a simplified broadband wireless network with point-to-multipoint (PMP) cellular-like architecture for operation at both licensed and licensed-exempt frequency bands typically below 11 GHz. Other types of architectures (not shown) such as mesh broadband wireless networks are permissible. A backbone IP (Internet Protocol) network 100 is connected to a broadband wireless network using radio access nodes (RANs) 102A and 102B. Each RAN is connected via a wired link such as an optical fiber (depicted as optical fiber links 103A, 103B and 103C) or point-to-point wireless link (not shown) to one or more radio cells (depicted between RAN 102A or 102B to radio cells 104A, 104B, and 104C). At the hub of a radio cell is a respective Base station (BS) 106A, 106B, and 106C. A Base Station system includes an advanced antenna system (AAS), which is typically located on top of a radio tower and is used to transmit high-speed data to multiple subscriber stations (SSs) 108 and mobile subscriber stations (MSSs) 109 and receive data from the subscriber stations via unidirectional wireless links 110 (each SS uplink transmission is independent on the others). More particularly, each SS 108 can access network 100 (via an appropriate BS) using the PHY+MAC (Physical+Media Access Control) layer features defined by the IEEE P802.16 air-interface standard. An SS may correspond to a fixed subscriber location (e.g., in a home or office), or may correspond to a mobile subscriber who might access the broadband wireless network via a mobile device (MSS) such as a personal digital assistant (PDA), laptop computer, etc. A fixed SS typically uses a directional antenna while an MSS usually uses an omni-directional antenna.

Transmission of data bursts from network 100 to an SS 108 proceeds in the following manner. The data bursts such as IP packets or Ethernet frames forwarded from an appropriate RAN to an appropriate BS within a given cell. The BS encapsulates the data into IEEE 802.16-2004 data frame format, and then transmits non-line-of-sight (NLOS) data to each SS 108 using a unidirectional wireless link 110, which is referred to as a “downlink.” Transmission of data from an SS 108 to network 100 proceeds in the reverse direction. In this case, the encapsulated data is transmitted from an SS to an appropriate BS using a unidirectional wireless link referred to as an “uplink.” The data packets are then forwarded to an appropriate RAN, converted to IP Packets or Ethernet frames, and transmitted henceforth to a destination node in network 100. Data bursts can be transmitted using either Frequency-Division-Duplexing (FDD), half-duplex FDD, or Time-Division-Duplexing (TDD) schemes. In the TDD scheme, both the uplink and downlink share the same RF channel, but do not transmit simultaneously, and in the FDD scheme, the uplink and downlink operate on different RF channels, but the channels are transmitted simultaneously.

Multiple BSs are configured to form a cellular-like wireless network. A network that utilizes a shared medium requires a mechanism to efficiently share it. Within each cell, the wireless network architecture is a two-way PMP, which is a good example of a shared medium; here the medium is the space (air) through which the radio waves propagate. The downlink, from the base station (BS) to an SS, operates on a PMP basis. Provisions within the IEEE 802.16-2004 standard and IEEE 802.16e/D5a draft specification (December, 2004) include a central BS with AAS within each cell. Such an AAS includes a sectorized antenna that is capable of handling multiple independent sectors simultaneously. Under this type of configuration, the operations of base stations described below may be implemented for each of the independent sectors, such that multiple co-located base stations with multiple sector antennas sharing a common controller may be employed in the network. Within a given frequency channel and antenna sector, all stations receive the same transmission, or parts thereof.

In the other direction, the subscriber stations share the uplink to the BS on a demand basis. Depending on the class of service utilized, the SS may be issued continuing rights to transmit, or the right to transmit may be granted by the BS after receipt of a request from an SS. In addition to individually-addressed messages, messages may also be sent on multicast connections (control messages and video distribution are examples of multicast applications) as well as broadcast to all stations. Within each sector, users adhere to a transmission protocol that controls contention between users and enables the service to be tailored to the delay and bandwidth requirements of each user application.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram of an exemplary broadband wireless network with point-to-multipoint topology based on the IEEE 802.16 suite of standards;

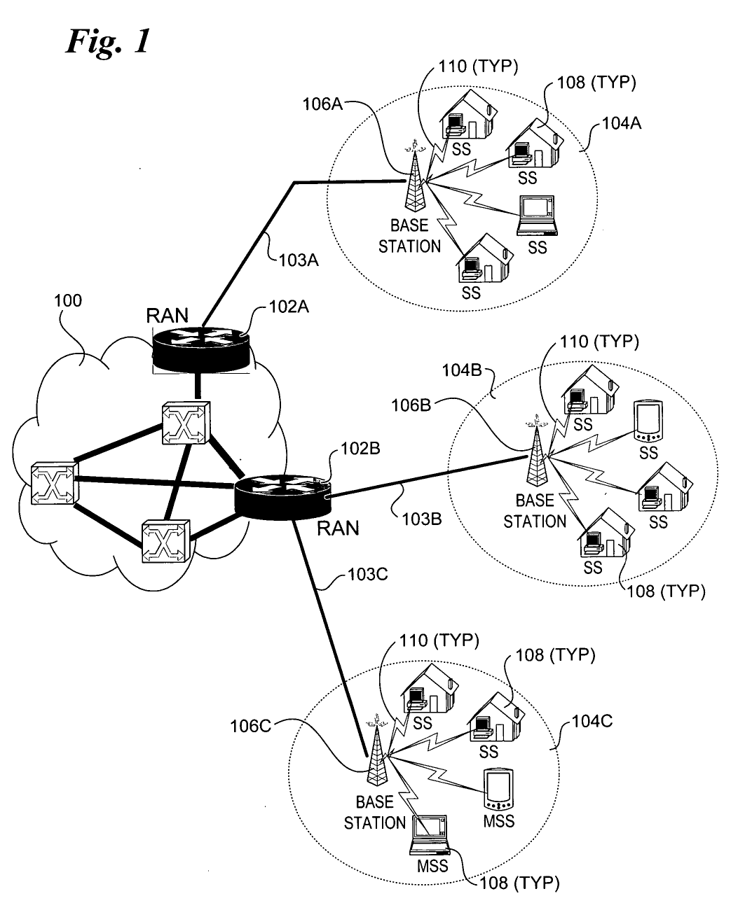

FIG. 2 is a schematic diagram of a management reference model for broadband wireless network architecture with mobile subscriber stations (MSSs), according to one embodiment of the invention;

FIG. 3a-e are schematic representations of a Management Information (data)Base (MIB) structure employed in the management reference model of FIG. 2 to facilitate provisioning and management operations;

FIG. 4a shows an exemplary configuration for a wireless MAN (metropolitan area network) base station (BS) provisioned service flow table corresponding to the wmanIfBsProvisionedSfTable object of FIG. 3, according to one embodiment of the invention;

FIG. 4b shows an exemplary configuration for a wireless MAN BS service class table corresponding to the wmanIfBsServiceClassTable object of FIG. 3, according to one embodiment of the invention;

FIG. 4c shows an exemplary configuration for a wireless MAN BS classifier rule table corresponding to the wmanIfBsClassifierRuleTable object of FIG. 3, according to one embodiment of the invention;

FIG. 4d shows an exemplary configuration for a wireless MAN BS registered subscriber station table corresponding to the wmanIfBsRegisteredSsTable object of FIG. 3, according to one embodiment of the invention;

FIG. 4e shows an exemplary configuration for a wireless MAN common service flow table corresponding to the wmanIfCmnCpsServiceFlowTable object of FIG. 3, according to one embodiment of the invention;

FIG. 5 is a schematic diagram illustrating a scheme via which service classes may be provisioned, according to one embodiment of the invention;

FIG. 6 is a flowchart illustrating operations performed during provisioning service flows for a mobile subscriber station, according to one embodiment of the invention;

FIG. 7 is a flowchart illustrating details of the service flow provisioning operations of block 604 in FIG. 6;

FIG. 8 is a schematic diagram illustrating an exemplary set of table entries made to the tables of FIGS. 4a-e during the service flow provisioning operations of FIG. 6;

FIG. 9 is a flowchart illustrating details of the dynamic service flow parameter download operation of block 606 in FIG. 6;

FIG. 10 is a flowchart illustrating operations and logic performed during one embodiment of a hand-over procedure used to migrate the air interface for an MSS from a serving BS to a target BS;

FIG. 11 is a flowchart illustrating details of the hand-over procedure operations of block 1008 in FIG. 10;

FIG. 12 is a flowchart illustrating details of the dynamic service flow parameter download operation of block 1012 in FIG. 10; and

FIG. 13 is a schematic diagram of a broadband wireless communications apparatus that may be employed by a mobile subscriber station or base station to perform aspects of the embodiments described herein.

### DETAILED DESCRIPTION

Embodiments of a method and systems of network management and service provisioning for mobile broadband wireless networks are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

One of the more important aspects designed into 802.16-based broadband wireless networks is the ability to support mobile subscribers. Notably, this is one of the weak links with present cellular-based networks. While modern “2½ G” and “3 G” cellular services enable subscribers to receive and send data from mobile platforms, the transmission rates are relatively poor. A significant reason for this is that the underlying delivery mechanisms (the cellular networks) were originally intended for voice communication, which requires relatively low transmission rates.

The MBWA architecture being standardized by the WiMAX forum Network Working Group (NWG) is targeted to provide support for high transmission rates for mobile subscribers. At the same time, the MBWA architecture has also been designed to support the rich service capabilities such as high-speed data, streaming videos, and voice-over-IP (VoIP) services that were originally targeted for fixed subscriber stations to fulfill the “last mile” service requirements.

Another important aspect of WiMAX networks is service provisioning. To enable end-user access to a WiMAX network, the user's SS and service flows (i.e., unidirectional flow of MAC service data units on a connection with a particular quality of service (QoS)) must be provisioned. Unlike the limited QoS support provided by the more simplistic Wi-Fi (i.e., IEEE 802.11) networks commonly used to provide wireless network access in today's environments, the IEEE 802.16 architecture supports a rich set of QoS features. Furthermore, WiMAX employs a more sophisticated wireless air interface than does Wi-Fi, thus requiring more complex service provisioning considerations.

More specifically, WiMAX is based on a centralized control architecture, where the scheduler in the BS has complete control of the wireless media access among all SS's within its cell. WiMAX can simultaneously support multiple wireless connections that are characterized with a complete set of QoS parameters. Moreover, WiMAX provides the packet classifier to map these connections with various user applications and interfaces, ranging from Ethernet, TDM (Time-Division Multiplexing), ATM (Asynchronous Transfer Mode), IP (Internet Protocol), VLAN (Virtual Local Area Network), etc. However, the rich feature set and flexibility in WiMAX also increases the complexity in the service deployment and provisioning for fixed and mobile broadband wireless access networks.

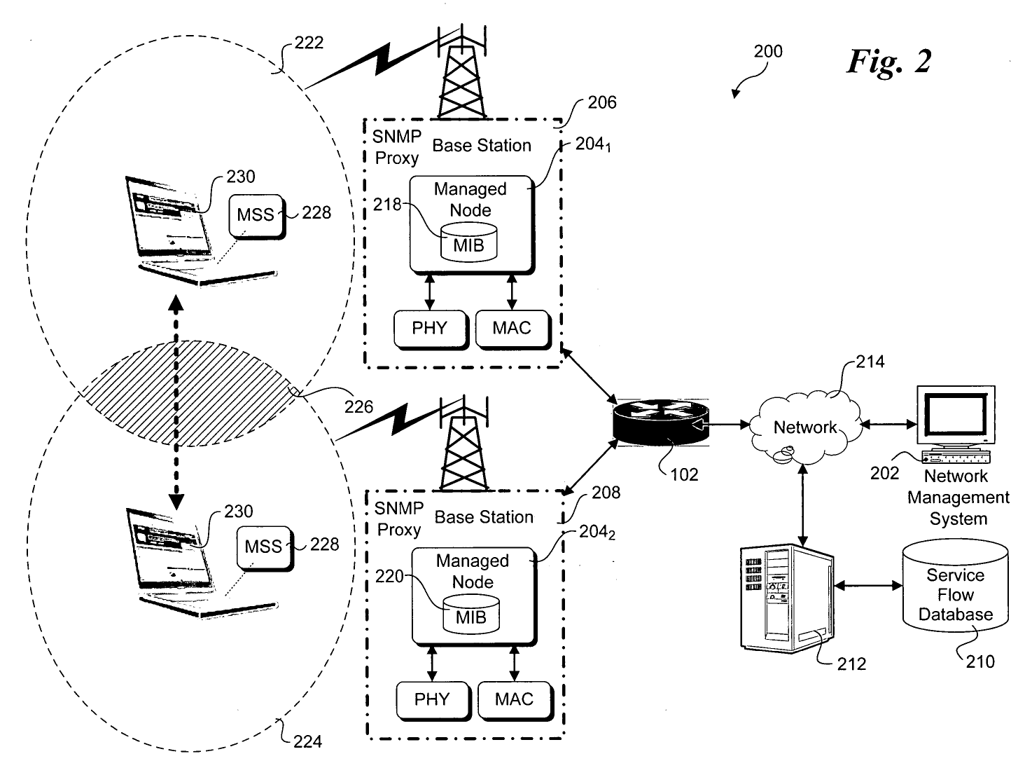

FIG. 2 shows a management reference model 200 of Broadband Wireless Access (BWA) networks, according to one embodiment of the invention. The model includes a Network Management System (NMS) 202, managed base station nodes (depicted as managed nodes 204₁ and 204₂ for exemplary base stations 206 and 208), and a Service Flow Database 210 hosted by a database server 212. The NMS 202 and Service Flow Database are linked in communication to the WiMAX network's BSs (e.g., base station 206 and 208) via a network 214, which may typically be a wide-area network (WAN) or public network (e.g., the Internet). The BS managed nodes collect and store managed objects in an 802.16 Management Information Base (MIB) format, as depicted by MIB instances 218 and 220. In one embodiment, managed objects are made available to NMSs (e.g., NMS 202) using the Simple Network Management Protocol (SNMP) as specified by IETF RFC (request for comments) 1157 (i.e., http://www.faqs.org/rfcs/rfc1157.html).

Each of base stations 206 and 208 provide a respective coverage area. The “footprint” (i.e., shape) of each coverage area will general depend on the type of antenna provided (e.g., single sector, multiple sector or omni-directional) by the base station in combination with geographical and/or infrastructure considerations and the power of the radio signal. For example, although referred to as non-line-of-sight (NLOS), geographical terrain such as mountains and trees, and public infrastructure such as large buildings may affect the wireless signal propagation, resulting in a reduced coverage area. The radio signal strength for WiMAX transmissions are also limited by the available RF spectrum for licensed and/or licensed-free operations. For simplicity, the respective coverage areas 222 and 224 for base stations 206 and 208 are depicted as ovals.

A given base station is able to support communication with both MSSs and fixed SSs within its coverage area. In order to support complete mobility, the coverage area of proximate “neighbor” base stations must have some degree of overlap, as depicted by an overlap coverage area 226 in FIG. 2. As an MSS moves throughout the coverage area (such as depicted by an MSS 228 moving between coverage areas 222 and 224), its signal-strength data is periodically gathered to assess which BS should be used to best maintain the current level of service. In view of this signal strength data, as well as other considerations detailed below, the BS used to provide services to a given MSS will be switched as the MSS moves within various BS coverage areas via a hand-over (HO) process. Details of hand-over process operations are described below.

As used herein, an MSS generally refers to an electronic system that enables two-way communication at Radio Frequencies (RFs) with base stations in a broadband wireless network. An MSS can be, for example, a IEEE 802.16e chipset inside an express card or network interface card, which plugs-in a mobile client platform, such as a notebook computer (e.g., notebook computer 230 depicted in FIG. 2), hand-held device (PDA, pocket PC, mobile phone, etc.).

The Service Flow Database 210 contains the service flow and the associated QoS information that directs the BS and SS/MSS in the creation of transport connections when a service is provisioned, an SS enters the WiMAX network, or a mobile SS roams into a BS coverage area. In general, SSs/MSSs can be managed directly from an NMS, or indirectly through a BS that functions as an SNMP proxy. In one embodiment, the management information between as SS/MSS and a BS is carried over a Second Management CID (Connection Identifier) for a managed SS/MSS. If the Second Management CID does not exist, the SNMP message may go through another interface provided by the customer premise equipment.

There are three types of service flows defined by the IEEE 802.16-2004 standard, including provisioned service flows, admitted service flows, and active service flows. A provisioned service flow is a service flow that is provisioned but not immediately activated. External triggers are use to transition a provisioned service flow to an admitted service flow. This service flow is initiated when an SS enters the network through a network entry procedure, with provision commands being managed by the NMS.

Under an admitted serve flow, a network resource is reserved through admission control. External triggers are used to transition an admitted service flow to an active service flow. Events similar to “off-hook” in a telephony model are employed to activate an unsolicited grant service (UGS) service flow. Application triggers may also be employed to effect the transition to an active service flow.

An active service flow is a service flow that is active. That is, it is a service flow that is granted uplink and downlink bandwidth for data transport usage. It employs an active QoS parameter set that is a subset of the Admitted QoS parameter set.

SNMP is based on the manager/agent model consisting of a manager, an agent, a database of management information, managed objects and the network protocol. The manager executes management applications that monitors and control managed network. The agent is a management software module that resides in a managed device to execute the commands from the manager.

The manager and agent use a Management Information Base (MIB) and a relatively small set of commands to exchange information. The MIB is organized in a tree structure with individual variables, such as point status or description, being represented as leaves on the branches.

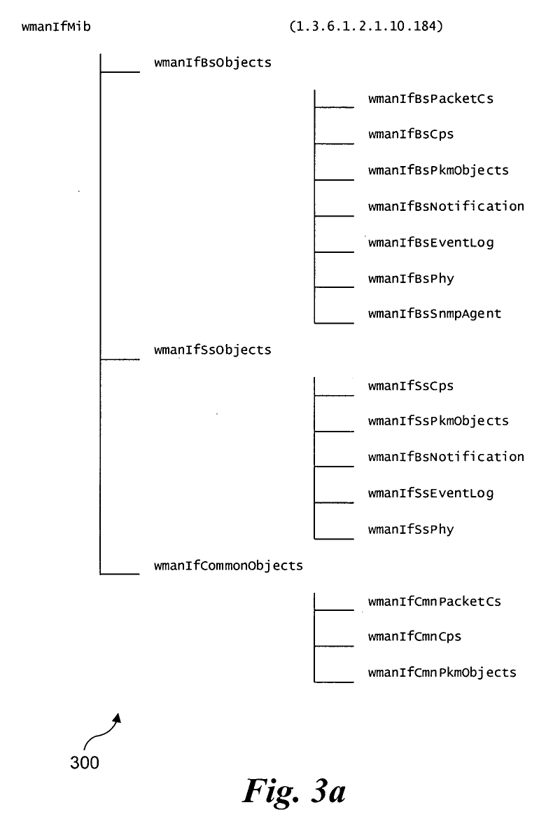

FIGS. 3a-e show various levels of detail for a wmanIfMib (wireless MAN interface) MIB data structure 300, according to one embodiment. The MIB data structure includes multiple MIB objects nested at various levels (groups) in an object hierarchy. At the top of the hierarchy is the wmanifMib object shown in FIG. 3a. The next hierarchy level includes the wmanifBsObjects, the wmanIfSsobjects, and the wmanIfCommonObjects. The wmanifBsObjects include a group of managed objects to be implemented by a base station; details of one embodiment of the wmanifBsObjects are shown in FIGS. 3b and 3c. Similarly, the wmanIfSsobjects include a group of managed objects to be implemented by a subscriber station; details of one embodiment of the wmanIfSsobjects are shown in FIGS. 3e. The wmanIfCommonObjects include a group of common managed objects to be implemented in base stations and the subscriber stations; details of one embodiment of the wmanIfCommonObjects are shown in FIGS. 3d. In connection with other SNMP management operations, wmanIfMib MIB data structure 300 may be implemented as a sub-tree under the Interfaces Group MIB defined in RFC (request for comment) 2863 (i.e., http://www.faqs.org/rfcs/rfc2863.html).

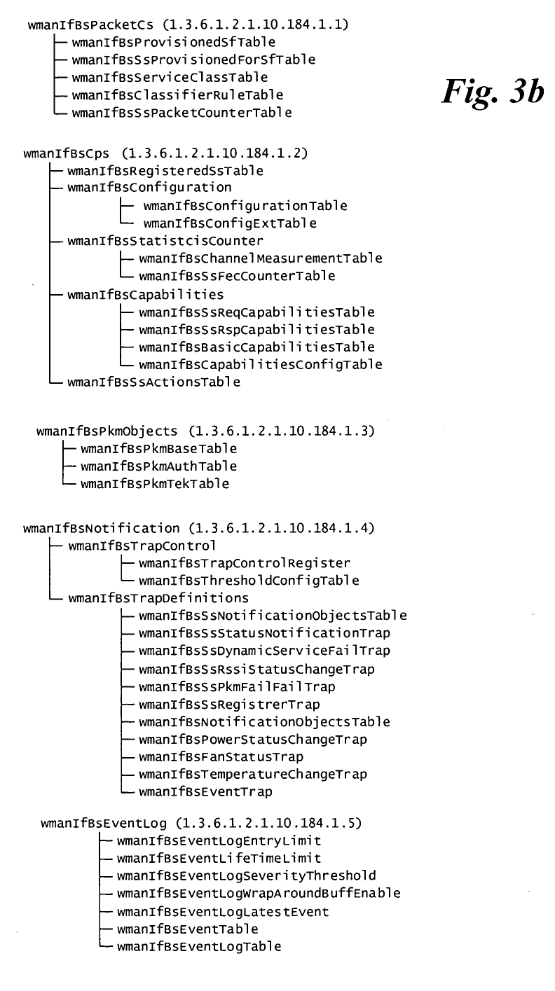

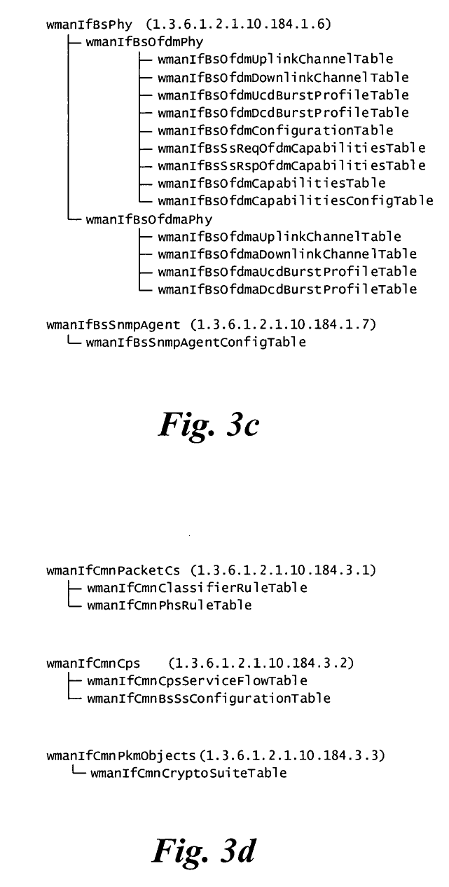

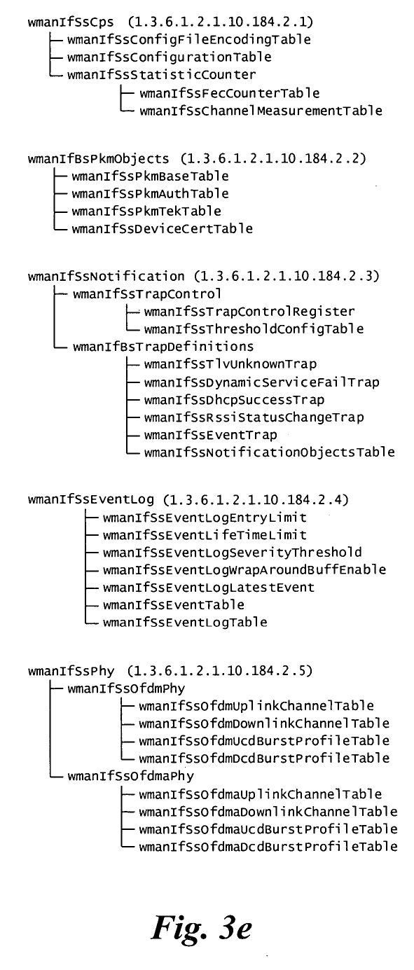

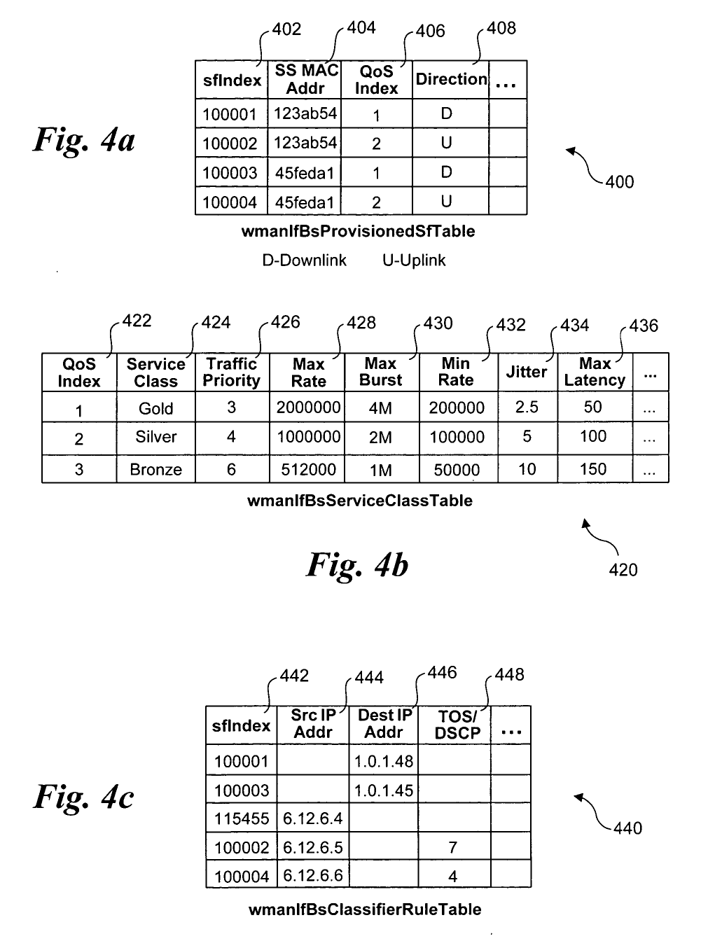

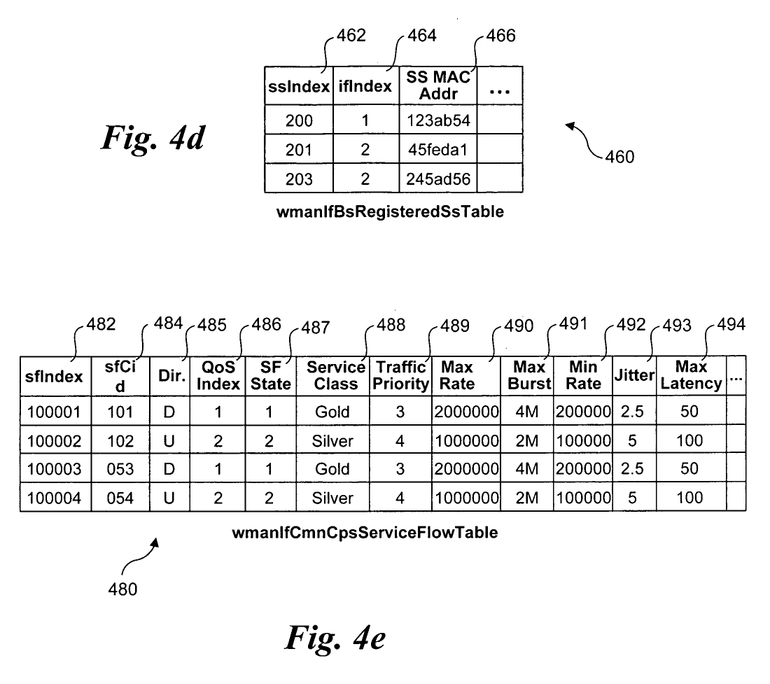

FIG. 4a shows an exemplary configuration of a BS provisioned service flow table (wmanIfBsProvisionedSfTable 400), according to one embodiment of the MIB data structure 300. This table contains the pre-provisioned dynamic service flow information to be used to create connections when a user enters the network. In includes an sfIndex field 402, an SS(/MSS) MAC address field 404, a QoS Index field 406, and a Direction field 408, among other fields (not shown). (For simplicity, only “SS”-related fields are shown in FIGS. 4a-e; it will be understood that these SS-related fields also pertain to similar MSS operations.) The sfIndex field 402 is used as an index to link table rows to other tables in the database. A corresponding dynamic service flow state value (provisioned, admitted, or activated) is stored in a linked table (not shown) for each index entry. The SS MAC address field 404 contains a unique SS identifier to associate the dynamic service flow with an SS. The QoS Index field 406 stores a pointer (index) to the QoS parameter set for the corresponding service flow identified by 422 in FIG. 4b. The Direction field 408 defines the direction of the service flow (e.g., uplink (UL) or downlink (DL)).

FIG. 4b shows an exemplary configuration for a BS service class table (wmanIfBsServiceClassTable 420), according to one embodiment of the MIB data structure 300. This table contains the QoS parameters that are associated with service flows. The illustrated fields include a QoS Index field 422, a Service Class field 424, a Traffic Priority field 426, a Maximum Sustained Data Rate field 428, a Maximum Traffic Burst field 430, a Minimum Reserved Rate field 532, a Tolerated Jitter field 434, and a Maximum Latency field 436. The QoS Index field 422 is analogous to QoS Index field 406, and stores a pointer (index) to the QoS parameter set for the corresponding dynamic service flow. The Service Class field 424 stores a service class name. In one embodiment, the level of service class names are linked to respective sets of QoS parameters, such that a particular set of commonly used QoS parameters may be identified by simply entering a corresponding service class name.

The Traffic Priority field 426 contains a value (e.g., 0, . . . , 7) that specifies the priority assigned to an active service flow. When two service flows have identical QoS parameters besides priority, the higher priority service flow should be given lower delay and higher buffering preference. The Maximum Sustained Data Rate field 428 specifies the peak data rate of the dynamic service flow in bits per second. The Maximum Traffic Burst field 430 specifies the maximum burst size that can be transported. The Minimum Reserved Rate field 432 is used to specify a rate in bits per second that specifies the minimum amount of data to be transported on the service flow when averaged over time. The Tolerated Jitter field 434 is used to specify the maximum frequency delay variation (jitter) for the service flow. The Maximum Latency field 436 specifies the maximum latency between the reception of a packet by the BS or SS on its network interface and the forwarding of the packet to its radio frequency (RF) interface.

FIG. 4c shows an exemplary configuration for a BS classifier rule table (wmanIfBsClassifierRuleTable 440), according to one embodiment of the MIB data structure 300. This table contains rules for the packet classifier to map downlink and uplink packets to the dynamic service flow. The table's fields include an sfIndex field 442 (analogous to sfIndex field 402), a Source IP Address field 444 in which the IP address for a source endpoint is stored, a Destination IP Address field 446, in which the IP address for a destination endpoint is stored, and a Type of Service (TOS)/Differentiated Service Code Point (DSCP) field 448, in which a TOS or DSCP parameter is stored. In the downlink direction, when a packet is received from the network, the classifier in the BS may use the MAC address or IP address to determine which SS the packet shall be forwarded to, and may use TOS or DSCP parameters to select the dynamic service flow with a suitable QoS. In the uplink direction, when a packet is received from the customer premise, the classifier in the SS may use the source/destination MAC address or IP address and port number, TOS/DSCP, Virtual Local Area Network (VLAN) ID to forward the packet to a service flow with the appropriate QoS support.

FIG. 4d shows an exemplary configuration of a BS registered SS table (wmanIfBsRegisteredSsTable 460), according to one embodiment of the MIB data structure 300. This table includes information corresponding to registered SSs. The illustrated fields include an ssIndex field 462, which contains an index to a subscriber station identifier, and an ifIndex field 464, which contains in interface index into an MIB instance. An SS MAC address field 466 is used to store the MAC address for a subscriber station.

FIG. 4e shows an exemplary configuration of a common dynamic service flow table (wmanIfCmnCpsServiceFlowTable 480), according to one embodiment of the MIB data structure 300. This table includes a service flow index (sfIndex) field 482, a service flow connection identifier (sfCid) field 484, a Direction Field 485, a QoS Index field 486, and a service flow state field 487. The remaining fields shown are analogous to like-named field in the smanIfBsServiceClassTable 420, and include a Service Class Name field 488, a Traffic Priority field 489, a Maximum Sustained Data Rate field 490, a Maximum Traffic Burst field 491, a Minimum Reserved Rate field 492, a Tolerated Jitter field 493, and a Maximum Latency field 494. These fields are populated with the same QoS parameters stored in wmanIfBsServiceClassTable 420 corresponding to their associated service class name. In addition to the illustrated fields, the smanIfCmnCpsServiceFlowTable may contain other fields that are not shown.

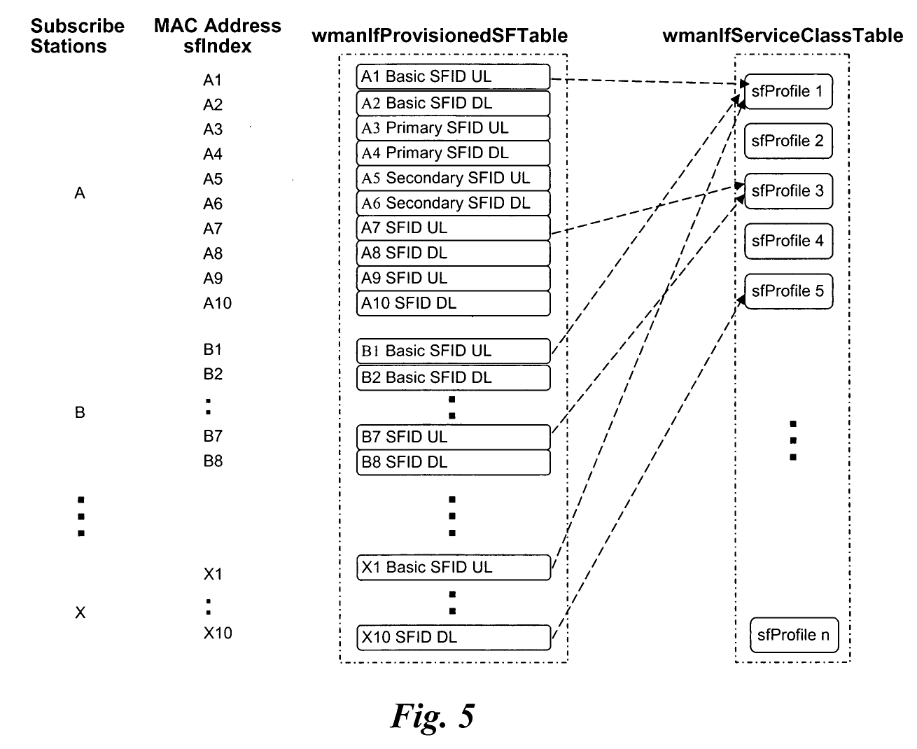

To facilitate the NMS task of provisioning dynamic service flow attributes for hundreds or even thousands of subscriber stations supported by each BS, the concept of Provisioned Service Classes has been devised. FIG. 5 shows one embodiment of a provisioned service class scheme, wherein QoS profiles (e.g., service classes) are created to define associated service flow attributes that can be shared by multiple service flows. For example, Basic CID UL for SSs A1, B1, and X1 uses service profile 1. Service flow attribute profiles can be added or deleted dynamically to meet different QoS demands from subscribers.

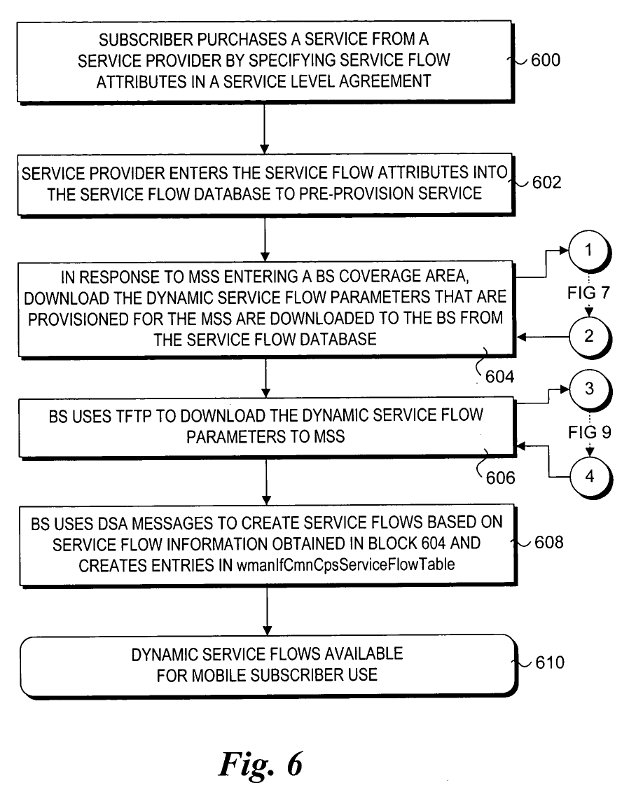

FIG. 6 shows a flowchart illustrating operations performed to provision dynamic service flows for a mobile subscriber, according to one embodiment of the invention. The process begins in a block 600, wherein the subscriber purchases a broadband wireless service from a service provider by specifying dynamic service flow attributes in a service level agreement. When a customer subscribes to the service, he or she will communicate the service provider the dynamic service flow information corresponding to the desired level of service, including the number of UL/DL connections that are requested, along with the data rates and QoS parameters for those connections, and along with what kind of applications (e.g., Internet, voice, video, etc.) he or she intends to run. In response to the subscriber entries, the service provider will pre-provision the services by entering the corresponding dynamic service flow attributes in Service Flow Database 216, as shown in a block 602.

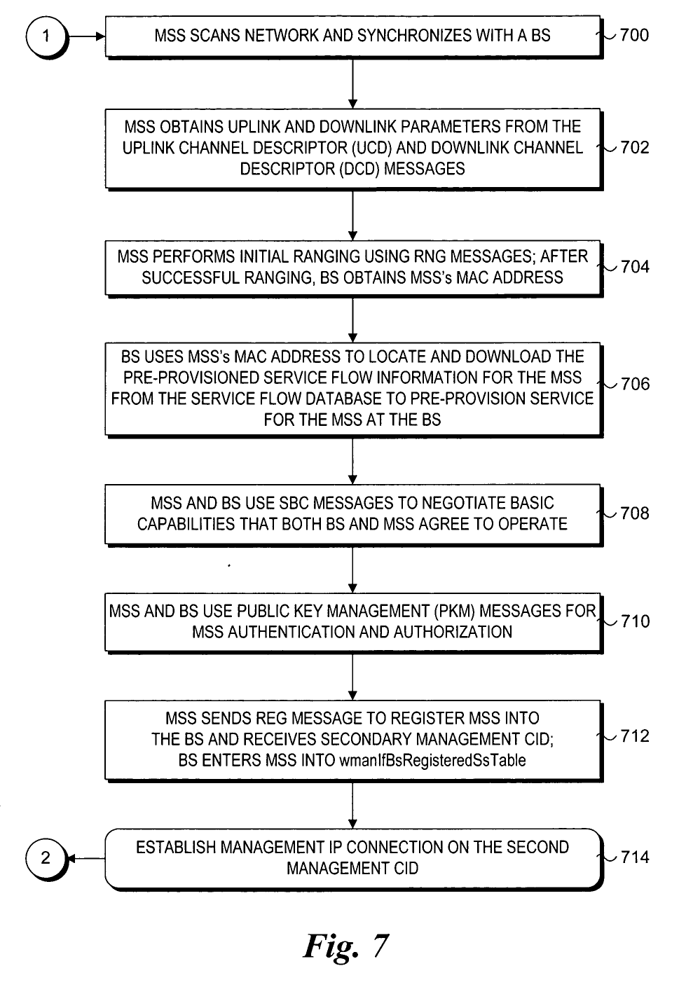

In response to an MSS entering a BS coverage area, the BS downloads dynamic service flow parameters that are provisioned for the MSS from service flow database in a block 604. Details of one embodiment of these operations are shown in FIG. 7.

The process begins in a block 700, wherein an MSS performs a scanning operation and synchronizes with BS. Generally, scanning is performed to identify base stations within the range of the MSS and select the best BS to provide service for the MSS. During scanning, an MSS scans neighboring BS to measure radio signal reception strength. In further detail, a carrier-to-interference plus noise ratio (CINR) and/or relative-signal strength indicator (RSSI) are measured to a resolution of 0.5 decibels (dB) using a pre-defined process and message exchange sequence. Prior to performing a scan, an MSS and its serving BS exchange MOB_SCN_REQ (mobile scan request) and MOB_SCN_RSP (mobile scan response) message to set up a timeframe for performing the scan. Once a BS is selected to serve the MSS, the MSS and BS perform a synchronization operation to establish uplink and downlink communication channels.

In a block 702, the MSS obtains uplink and downlink parameters from corresponding uplink channel descriptor (UDC) and downlink channel descriptor (DCD) messages. The MSS then performs initial ranging using RNG messages. Under this operation, the MSS sends a RNG_REQ ranging request message to a BS, which returns an RNG_RSP ranging response message containing current ranging information. After successful ranging, the BS obtains the MSS's MAC (Media Access Channel) address.

In a block 706, the BS uses the MSS's MAC address as a lookup parameter to download the service flow information corresponding to the MSS (entered above in block 602) from service flow database 210 (via server 212, network 214 and RAN 102) to pre-provision service for the MSS at the BS. In conjunction with the operations of block 706, the wmanIfBsProvisionedSfTable is populated with the corresponding service flow information, while corresponding QoS parameters are entered in the wmanIfBsServiceClassTable and corresponding classifier rules are entered in the wmanBsClassifierRuleTable.

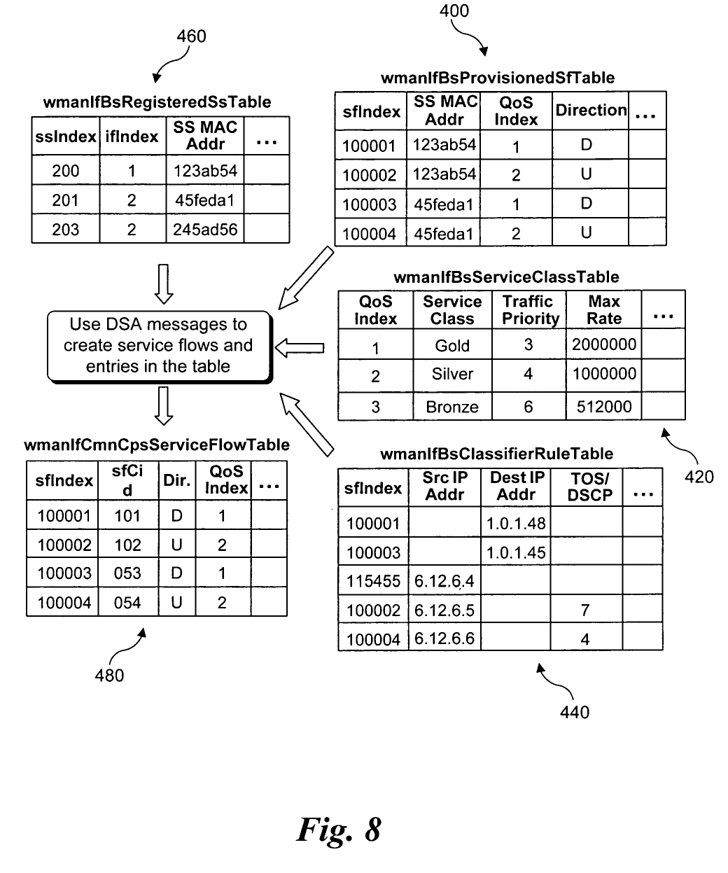

FIG. 8 shows exemplary entries in the aforementioned wmanIfBsProvisionedSfTable 400, wmanIfBsServiceClassTable 420, wmanBsClassifierRuleTable 440, wmanifBsRegisteredSsTable 460, and wmanIfCmnCpsServiceFlowTable 480 corresponding to a provisioning process. As shown by wmanIfBsProvisionedSfTable 400, two MSS's, identified by respective MAC addresses of 0x123ab54 and 0x45fead1, have been pre-provisioned. Each MSS has two dynamic service flows, identified by the values in the sfIndex field, with the associated QoS parameters that are identified by QoSIndex 1 and 2, respectively. As discussed above, a QoSIndex points to a QoS entry in the wmanIfBsServiceClassTable that contains QoS parameters. The wmanIfBsServiceClassTable 420 shown in FIGS. 4 and 8 includes three levels of QoS: Gold, Silver, and Bronze. The sfIndex values point to corresponding entries in wmanBsClassifierRuleTable 440 having the same sfIndex value. The entries in wmanBsClassifierRuleTable 440 indicate which rules shall be used to classify packets on the given dynamic service flow. wmanBsClassifierRuleTable 440 contains an entry that is indexed by sfIndex 100001, indicating a downlink service flow, and contains destination IP address 1.0.1.48. This means that the classifier in the BS will forward the packet with destination IP address 1.0.1.48, received from the RAN 102, to the service flow with sfIndex 100001. wmanBsClassifierRuleTable 440 also contains an entry that is indexed by sfIndex 100002, indicating a uplink service flow, and contains source IP address 6.12.6.5, and TOS 7. This means that the classifier in the MSS will transmit the packet with source IP address 6.12.6.5 and TOS 7 to the service flow with sfIndex 100002.

After the appropriate BS MIB tables are updated with the pre-provisioned service flow data, the MSS and BS exchange subscriber basic capability (SBC) messages to negotiate basic capabilities that both the BS and MSS agree to operate, as depicted in a block 708. Next, in a block 710, the MSS and BS use public key management (PKM) messages for MSS authentication and authorization according to IEEE 802.16e/D5a draft specification (December, 2004). As depicted in a block 712, the MSS then sends a REG message to register the MSS into the BS and receives a secondary management CID. The BS then enters the MSS into its wmanIfBsRegisteredSsTable 460 using its MAC address to identify the MSS. In the present example, a MAC address 0x123ab54 is entered, as shown in the first row of wmanifBsRegisteredSsTable 460 in FIG. 8. Based on the MAC address, the BS will be able to find the service flow information that has been pre-provisioned for the MSS in wmanIfBsProvisionedSfTable 400, wmanIfBsServiceClassTable 420, and wmanBsClassifierRuleTable 440.

A management IP connection is then established on the secondary management CID in a return block 714. In one embodiment, the management IP connection is extended to the host device for the MSS (e.g. notebook, PDA (personal digital assistant, hand-held personal computer, etc.), which runs an IP application.

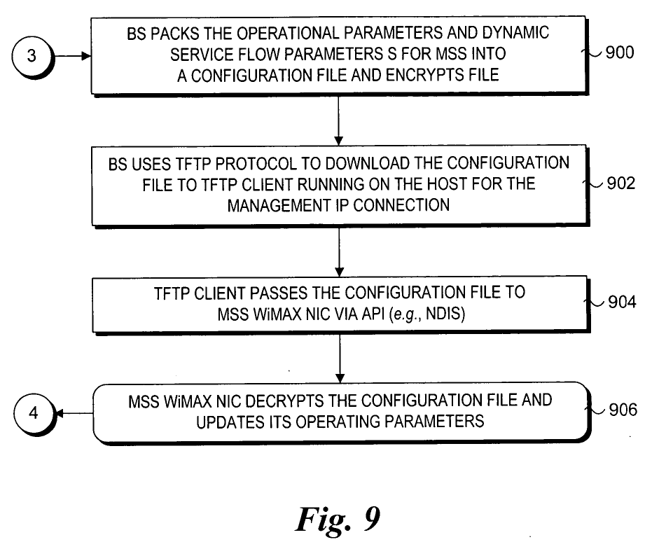

Returning to a block 606 in FIG. 6, after the operations of the flowchart of FIG. 7 are performed, the BS downloads the operational parameters and dynamic service flow parameters as defined in the wmanIfMib to the MSS. Details of one embodiment of the operations for block 606 are shown in FIG. 9.

The process starts in a block 900, wherein the BS packs the operational parameters and dynamic service flow parameters for the MSS into a configuration file and encrypts the file. In a block 902, the BS uses the trivial file transfer protocol (TFTP) to download the configuration file to a TFTP client running on the host device for the management IP connection. The TFTP client then passes the configuration file to the WiMAX NIC for the MSS via an appropriate API (application program interface), such as Network Driver Interface Specification (NDIS). The MSS WiMAX NIC then decrypts the configuration file an updates its operating parameters in a return block 806.

Continuing at a block 608 in FIG. 6, upon completing the download of the operational parameters and dynamic service flow parameters, the BS uses Dynamic Service Addition (DSA) messaging to the MSS to create dynamic service flows with the pre-provisioned dynamic service flow information obtained in block 604 and creates corresponding entries in the wmanIfCmnCpsServiceFlowTable 480 (e.g., sfIndex entries 100001 and 100002 for the present example depicted in FIG. 8). Details of the DSA message syntax can be found in Section 6.3.2.3.10 for the DSA-REQ message, Section 6.3.2.3.11 for the DSA-RSP message, and in Section 6.3.2.3.12 for the DSA-ACK message in IEEE 802.16-2004 standard.

As discussed above, wmanIfCmnCpsServiceFlowTable 480 contains both service flow information and QoS parameters. Depending on the network condition, the QoS parameters in wmanIfCmnCpsServiceFlowTable 480 may correspond to a lower service level than what have been pre-provisioned for a given MSS in wmanIfBsProvisionedSfTable 400. In one embodiment, the classifier rules will be created in the classifier rules table (not shown) in the BS. The dynamic service flows will then be available for the subscriber to send data traffic, as depicted by an end block 610. In response to appropriate conditions that invoke corresponding triggers, the pre-provisioned service flows will be advanced to admitted and then active service flows.

As an MSS moves throughout a network coverage area, its signal-strength will vary such that a hand-over process is warranted. More particularly, the HO process is the process under which an MSS migrates from the air-interface provided by a (currently) serving BS to the air-interface provided by a target (for future service) BS. Upon HO completion, the target BS becomes the new serving BS. Under a conventional HO process, the MSS needs to synchronize with the target BS downlink channel, obtain the uplink parameters and perform its network re-entry process, including re-authorization, re-registration, and re-establish its IP connectivity in a manner similar to that employed for new MSS entering the network according to the IEEE 802.16e/D5a draft specification (December, 2004). This conventional HO process requires a large amount of message traffic, resulting in a significant time-delay as well as significant workload levels at the BSs.

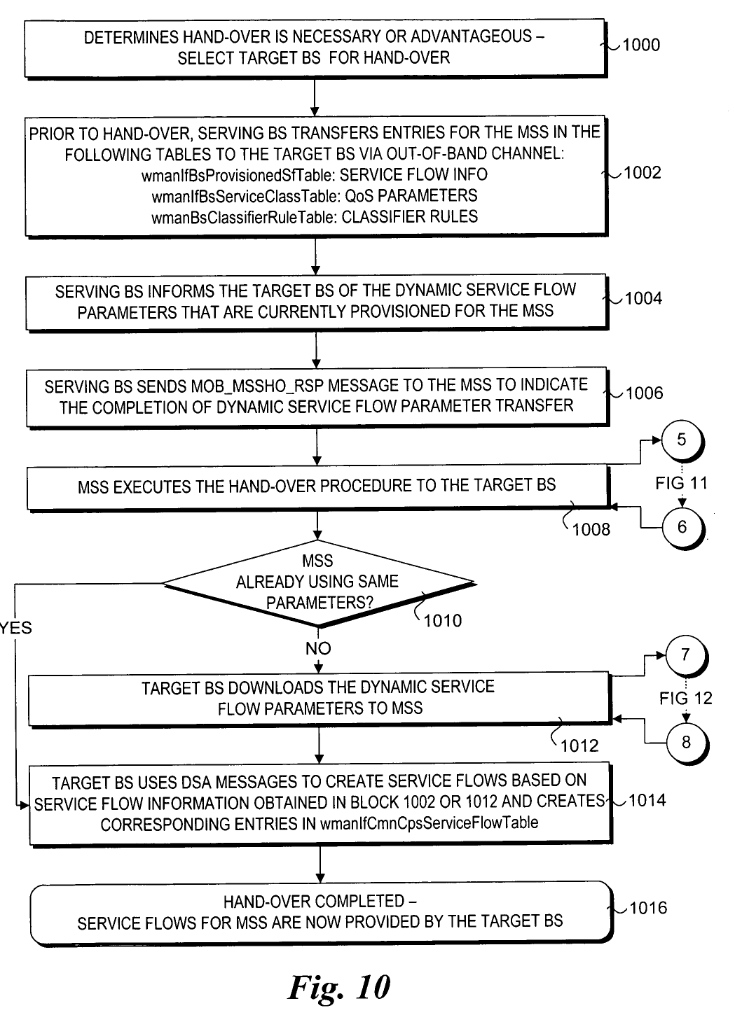

Operations and logic corresponding to one embodiment of a hand-over process are shown in FIG. 10. A hand-over begins with a decision for an MSS to hand-over its air interface, service flow, and network attachment from a serving BS to a target BS. Accordingly, the HO process begins in a block 1000, wherein a determination is made to a need or benefit to migrating an existing service from a serving BS to a new (target) BS. The decision may originate either at the MSS, the serving BS, or the network manager. Typically, the HO decision will be made based on service criteria (e.g., which BS will provide the best air-interface to the MSS) and BS bandwidth availability considerations. In connection with this determination is the ongoing process of cell selection.

Cell selection refers to the process of an MSS scanning and/or ranging one or more BSs in order to determine suitability, along with other performance considerations, for network connection or hand-over. The MSS may incorporate information acquired from a MOB_NBR-ADV (mobile neighbor advertisement) message to give insight into the available neighboring BSs for cell selection consideration. If currently connected to a serving BS, an MSS shall schedule periodic scanning intervals or sleep-intervals to conduct cell selection for the purpose of evaluating MSS interest in hand-over to potential target BSs. This procedure does not involve termination of existing connections to a serving BS and their re-opening in a target BS. If ranging a target BS for hand-over, any newly assigned basic and primary CIDs (connection identifiers) are specific to the target BS and do not replace or supplant the basic and primary CIDs the MSS employs in its communication with its serving BS.

In view of these cell selection operations, an MSS periodically scans neighboring BS to measure radio signal reception strength. As discussed above, a CINR and/or RSSI value is measured using a pre-defined process and message exchange sequence, which is proceeded by the aforementioned MOB_SCN_REQ and MOB_SCN_RSP message exchange to set up a timeframe for performing the scan. As another option, a serving BS may initiate scanning activities by sending a NBR_ADV (Neighbor Advertisement) message to the MSS. The message informs the MSS of a number of local neighbors from which it might obtain better service. In response to the message, the MSS and serving BS exchange MOB_SCN_REQ and MOB_SCN_RSP messages and then the MSS scans the neighbor BSs identified in the MOB-NBR-ADV message. In one embodiment, the determination of block 1000 is made by an MSS in view of the foregoing scanning operations.

In one embodiment, an MSS employs a MSS Channel Measurement Table with the following structure to store channel measurement data:

WmanIfCmnMssChMeasurementEntry ::= SEQUENCE {

| | |
|---|---|
| wmanIfCmnSsIdIndex | Unsigned32, |
| wmanIfCmnChannelNumber | INTEGER, |
| wmanIfCmnStartFrame | INTEGER, |
| wmanIfCmnDuration | INTEGER, |
| wmanIfCmnBasicReport | BITS, |

| | |
|---|---|
| wmanIfCmnMeanCinrReport | INTEGER, |

| | |
|---|---|
| wmanIfCmnStdDeviationCinrReport | INTEGER, |

| | |
|---|---|
| wmanIfCmnMeanRssiReport | INTEGER, |

| | |
|---|---|
| wmanIfCmnStdDeviationRssiReport | INTEGER |
| } | |

In one embodiment; an BS employs a BS Channel Measurement Table with the following structure to store channel measurement data:

WmanIfBsChMeasurementEntry ::= SEQUENCE {

| | |
|---|---|
| wmanIfBsChSsIdIndex | Unsigned32, |
| wmanIfBsChannelNumber | INTEGER, |
| wmanIfBsStartFrame | INTEGER, |
| wmanIfBsDuration | INTEGER, |
| wmanIfBsBasicReport | BITS, |
| wmanIfBsMeanCinrReport | INTEGER, |
| wmanIfBsMeanRssiReport | INTEGER |
| } | |

In one embodiment, the serving BS transfers a copy of entries for the MSS contained in its wmanIfBsProvisionedSfTable 400, wmanIfBsServiceClassTable 420, and wmanBsClassifierRuleTable 440 to the target BS prior to the handoff, using an out-of-band channel, as depicted in a block 1002. For instance, a management channel hosted by an Ethernet link or the like may be maintained between the various base stations for a broadband wireless network. Optionally, or wireless-based management channel may be employed for similar purposes. The operation of block 1002 produces a result similar to the BS service pre-provisioning operation of 604 discussed above, except in the case the service information is forwarded from a serving BS to the target BS rather than being sent from service flow database 210.

In one embodiment, the serving BS builds an MIB sub-tree export containing current MSS service data stored in appropriate tables, including wmanIfBsProvisionedSfTable 400, wmanIfBsServiceClassTable 420, and wmanBsClassifierRuleTable 440. The serving BS then sends an SNMP encapsulated message containing the MIB sub-tree export. The sub-tree is then extracted by the target BS and parsed. The wmanIfBsProvisionedSfTable 400, wmanIfBsServiceClassTable 420, and wmanBsClassifierRuleTable 440 in the local MIB instance at the target BS are then populated with the parsed sub-tree data.

In a block 1004 the serving BS informs the target BS of the dynamic service flow parameters that are currently provisioned for the MSS. The serving BS then sends an MOB_MSSHO_RSP (mobile MSS hand-over response) message to the MSS to inform the MSS that the transfer of dynamic service flow parameters to the target BS has been completed, as depicted in a block 1006.

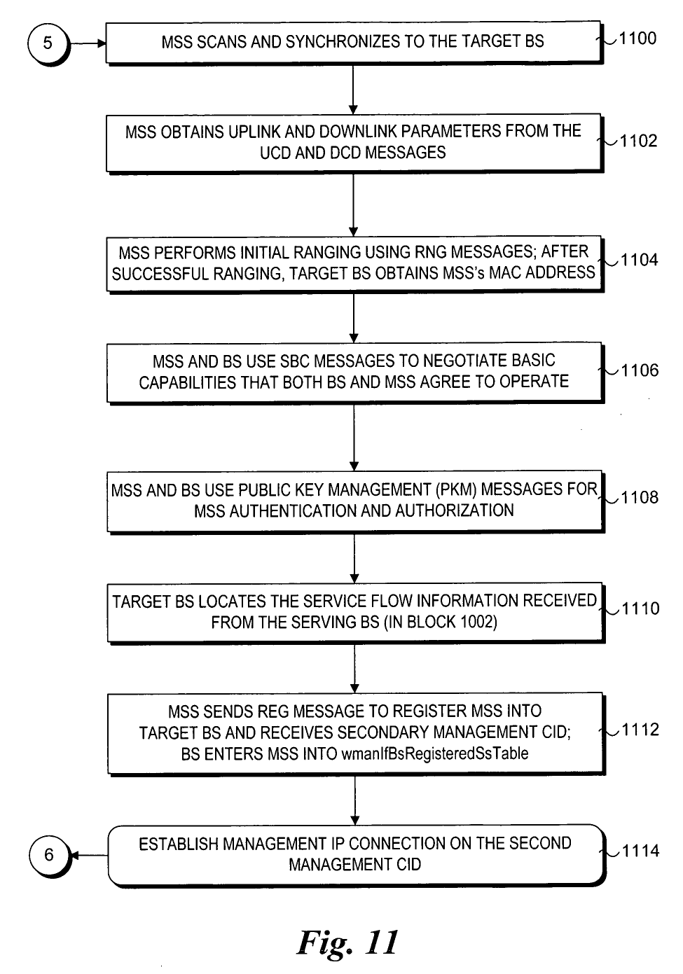

At this point, the MSS is ready to perform the hand-over of its air interface from the serving BS to the target BS, the operations of which are generally depicted by a block 1008, while details of one embodiment of this process are shown in FIG. 11 In general, many of the operations are similar to those discussed above with reference to the operations of FIG. 7.

The process begins in a block 1100, wherein the MSS scans and synchronizes with the target BS in a manner similar to that described above for block 700 of FIG. 7. In a block 1102, the MSS then obtains the uplink and downlink parameters via respective UCD and DCD messages in manner similar to that described above for block 702. The MSS then performs initial ranging using RNG messages, and the target BS obtains the MSS's MAC address in a block 1104 in a manner similar to the operation of block 704 described above. The MSS and BS then use SBC messages to negotiate basic capabilities and agree on operating parameters in a block 1106 and us PKM messages for MSS authentication and authorization in block 1108 in a manner similar to that described above for respective blocks 706 and 708.

In a block 1110, the target BS locates the pre-provisioned service flow information that was received above in block 1002. The MSS then sends a REG message to register the MSS into the target BS and receives a secondary management CID in a block 1112, and enters the MSS into is wmanIfBsRegisteredSsTable. The processing of FIG. 11 is then completed in a return block 1114, wherein a management IP connection is established on the second management CID. Upon completion, the logic returns to block 1008.

Upon return, the logic proceeds to a decision block 1010, wherein a determination is made to whether the MSS is already using the same dynamic service flow parameters as those being provisioned by the target BS—in other words, the dynamic service flow parameters for the serving and target BS are the same. In one embodiment, this is identified by using a configuration tag. Under this approach, each configuration file has an associated tag indicating the version of the set of operational parameters and dynamic service flow parameters. In one embodiment, a standard set of configuration files is defined that can be reused across multiple base stations to simply the hand-over procedure. If the answer to decision block 1010 is YES, the logic proceeds directly to a block 1014, skipping a block 1012.

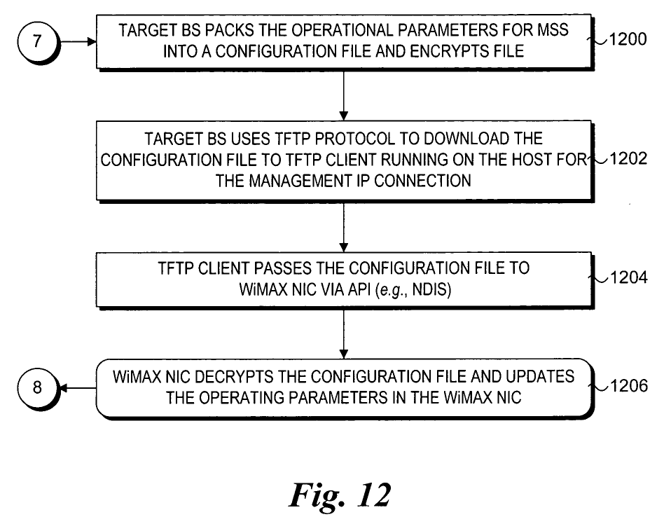

If the answer to decision block 1010 is NO, there is a need to obtain new operational and/or dynamic service flow parameters or the changes from the currently used parameters. Accordingly, the target BS downloads such dynamic service flow parameters in a block 1012. Details of this process are shown in FIG. 12, and are similar to those presented in FIG. 9 to provide dynamic service flow parameters to an MSS entering a broadband wireless network.

First, in a block 1200, the target BS packs the operational parameters for the MSS into a configuration file and encrypts the file. The target BS then sends the configuration file to a TFTP client running on the host for the management IP connection in a block 1202. The TFTP client then passes the configuration file to the WiMAX NIC via an appropriate MAC API in a block 1204, whereupon the WiMAX NIC decrypts the configuration file and updates the operating parameters in the WiMAX NIC in view of corresponding dynamic service flow parameters in a return block 1206, thus returning the logic to block 1012.

Continuing at block 1014, the target BS uses DSA messages to create service flows based on service flow information obtained in block 1002 (if the parameters are the same) or 1012 (if the parameters are different) and creates corresponding entries in its smanIfCmnCpsServiceFlowTable. As depicted by an end block 1016, this completes the hand-over process, and thus the service flows for the MSS are now provided by the target BS.

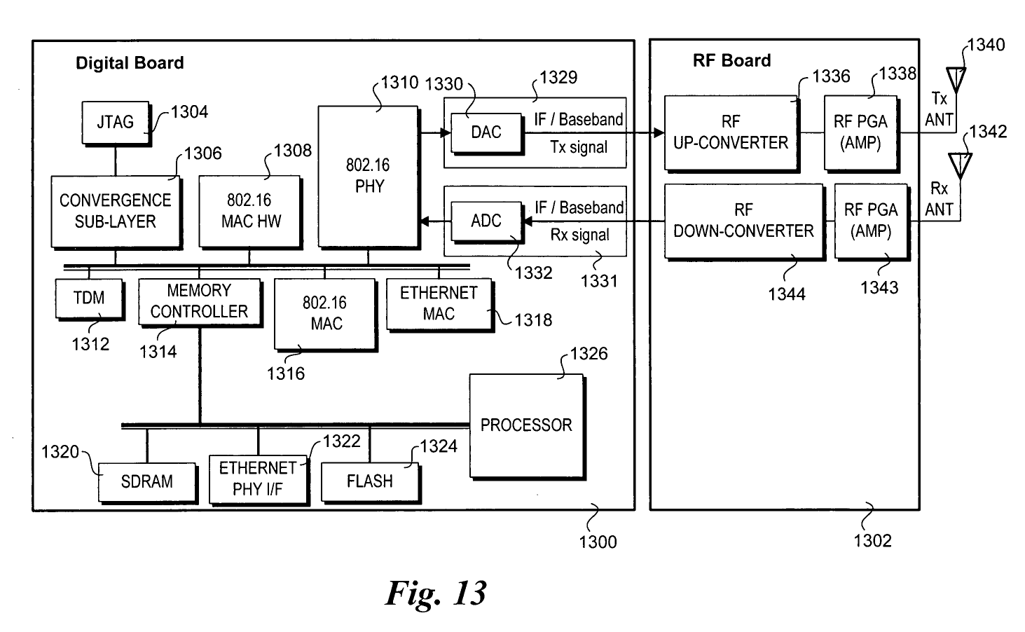

FIG. 13 shows a block diagram of broadband wireless system architecture suitable for use as a WiMAX NIC at a mobile subscriber station or base station under the IEEE 802.16-2004 specification. The architecture includes a digital board 1300 and a radio frequency (RF) board 1302. In general, digital board 1300 is responsible for performing various process operations discussed herein. Meanwhile, RF board 1302 handles the generation and reception of RF signals in accordance with the IEEE 802.16-2004 standard.

There are various building blocks and components employed by digital board 1300 to facilitate its process operations. These include an optional Joint Test Action Group (JTAG) component 1304, a convergence sub-layer 1306, an IEEE P802.16-2004 MAC hardware block 1308, an IEEE P802.16-2004 physical layer transceiver 1310, a TDM component 1312, a memory controller 1314, an IEEE P802.16-2004 MAC layer 1316, an Ethernet MAC block 1318, synchronous dynamic random access memory (SDRAM) 1320, an Ethernet physical interface 1322, flash memory 1324, and a processor 1326.

Since digital board process digital signals, while IEEE P802.16-2004 transmissions comprise analog signals, means are provided for interfacing between the two signal types. Furthermore, circuitry is needed to produce RF signals having appropriate baseband characteristics. These functions are facilitated by an IF/ (intermediate frequency) Baseband transmitter (Tx) signal chip 1329, which includes a digital-to-analog converter (DAC) 1330 and an IF/Baseband receiver (Rx) signal chip 1331 that includes an analog-to-digital converter (ADC) 1332. DAC 1330 chip converts digital signals generated by IEEE P802.16-2004 physical layer transceiver 1310 into a corresponding analog signal. This signal is fed into an RF up-converter 1336 on RF board 1302, which up-converts the baseband signal frequency to the carrier frequency. The up-converted signal is then amplified via a programmable gain amplifier (PGA) 1338, which outputs an amplified up-converted signal to a transmitter antenna 1340.

Incoming IEEE P802.16-2004 transmission signals are received at a receiver antenna 1342. The received signal is then amplified (as needed) via a PGA 1343 and provided as an input to an RF down-converter 1344, which down converts the received signal to the selected IF/Baseband frequency. The down-converted signal is then converted to a digital signal via ADC chip 1332.

In general, processor 1326 is representative of various types of processor architectures, including, but not limited to general-purpose processors, network processors, and microcontrollers. In addition, processor 1326 is representative of one or more processing elements. The operations performed by the various digital board layers and components are facilitated by execution of instructions on one or more processing elements, including processor 1326. Generally, the instructions may comprise firmware, software, or a combination of the two. In one embodiment, firmware instructions are stored in flash memory 1324. In one embodiment, software instructions are stored in a storage device, such as a disk drive (not shown), that is connected to processor 1326 via a disk controller (not shown). In one embodiment, all or a portion of the software instructions may be loaded as a carrier wave over a network, which interfaces to digital board 1300 via Ethernet physical interface 1322.

Thus, embodiments of this invention may be used as or to support a firmware and/or software modules executed upon some form of processing core or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

In addition to the configuration depicted in FIG. 13, the digital board 1300 and RF board 1302 functionality may be implemented via corresponding modules or that like that are embedded in a mobile subscriber station or base station. For example, a PDA or laptop computer may include circuitry corresponding to digital board 1300 and RF board 1302 that is built into the device. In other embodiments, the digital and RF board functions may be supported by a peripheral add-on card or module, such as a PCMCIA card for a laptop computer.

In general, the size of the MIB data stored at a base station will be much larger than the corresponding operational and dynamic service flow parameters maintained at an MSS. In general, the MIB data at the BS will comprise a small subset of the data stored in service flow database 214 (depending on the number of BSs for a given network). Typically, the SNMP agent operations may be implemented as a separate application running on an BS, or may be included as part of an 802.16 interface application used to access the network. The operational and dynamic service flow parameters may be stored in a memory store or a disk drive or the like. For larger MIB data requirements, it may be advantageous to employ a dedicated database server at a BS to serve the MIB data.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method for provisioning service flows in a broadband wireless network, comprising:
identifying a mobile subscriber station (MSS) attempting to enter a broadband wireless network;
retrieving pre-provisioned service flow parameters corresponding to the MSS; and
creating service flows for the MSS based on the pre-provisioned service flow parameters that are retrieved, the service flows enabling the MSS to access the broadband wireless network.

2. The method of claim 1, wherein the broadband wireless network employs an air interface defined by an IEEE (Institute of Electronic and Electrical Engineers) IEEE 802.16-based broadband wireless standard.

3. The method of claim 1, further comprising:
Storing service flow parameters for respective subscribers in a service flow database hosted by a wireless service provider;
obtaining an MSS identifier at a base station (BS) in response to the MSS attempting to access the broadband wireless network via the BS;
retrieving the service flow parameters from the service flow database based on the MSS identifier and returning the service flow parameters that are retrieved to the BS; and
storing the service flow parameters at the BS.

4. The method of claim 3, further comprising:
enabling a subscriber to subscribe to a service offered by the wireless service provider via a service level agreement that identifies service flow attributes defining service flows to be provisioned for the subscriber when accessing the broadband wireless network;
storing the service flow attributes in the storage flow database to pre-provision the service for the subscriber.

5. The method of claim 3, further comprising:
Storing service flow-related data in an Management Information Base (MIB) data structure at the BS; and
employing (Simple Network Management Protocol) messages to access the MIB data structure.

6. The method of claim 1, wherein creation of service flows is facilitated via a dynamic service addition (DSA) message exchange between the BS and the MSS.

7. The method of claim 1, further comprising:
building a configuration file containing operational parameters for the MSS to employ to support service flows provisioned for the MSS;
sending the configuration file from the BS to the MSS;
extracting the operational parameters from the configuration file; and
employing the operational parameters at the MSS to support the service flows

8. A method for performing a hand-over in a broadband wireless network, comprising:
determining a condition under which a hand-over of an air interface between a mobile subscriber station (MSS) and a serving base station (BS) to a target BS is necessary or would be advantageous;
identifying the target BS to which to migrate the air interface;
forwarding service flow information corresponding to pre-provisioned service flows for the MSS from the serving BS to the target BS;
pre-provisioning service flows for the air interface between the MSS and the target BS in view of the service flow information that was forwarded; and
providing service flows to the MSS via the target BS based on the pre-provisioned service flows.

9. The method of claim 8, wherein the broadband wireless network comprises a WiMAX network operated in conformance with an IEEE (Institute of Electrical and Electronic Engineering) 802.16-based wireless broadband standard.

10. The method of claim 8, further comprising:
passing information from the serving BS to the target BS identifying operational parameters currently employed to support the air interface between the MSS and the serving BS;
determining if the target BS can support the same operational parameters, and if so,
creating service flows for the migrated air interface between the MSS and the target BS using the same operational parameters; otherwise,
determining a different set of operational parameters that may be supported by the target BS; and
creating service flows for the migrated air interface using the different set of operational parameters.

11. The method of claim 10, further comprising:
defining a plurality of configurations, each configuration specifying operational parameters employed at an MSS to support a corresponding set of service flows;
building a configuration file for each configuration, each configuration file associated with a configuration identifier;
employing operational parameters corresponding to a first configuration file prior to support the air interface between the MSS and the serving BS prior to the hand-over;
determining if the target BS can support the same operational parameters by,
passing the configuration identifier associated with the first configuration file to the target BS;
identifying the operational parameters specified for the first configuration file based on the configuration identifier; and
determining whether the target BS can support the operational parameters that are identified.

12. The method of claim 8, further comprising:
storing subscriber service flow provisioning information in a service flow database;
storing respective sub-sets of the subscriber service flow provisioning information in Management Information Base (MIB) instances at the serving BS and the target BS;
storing pre-provisioned service flows for the MSS in the MIB instance at the serving BS; and, in response to initiation of a hand-over,
generating an MIB sub-tree structure containing the pre-provisioned service flows for the MSS;
sending the MIB sub-tree structure from the serving BS to the target BS;
extracting the pre-provisioned service flows from the MIB sub-tree structure; and
inserting information corresponding to the pre-provisioned service flows into the MIB at the target BS to pre-provision the service flows.

13. The method of claim 8, further comprising using Simple Network Management Protocol (SNMP) encapsulated messaging to forward the service flow information from the serving BS to the target BS.

14. A broadband wireless network system, comprising:
a radio access node (RAN);
a service flow database, communicatively-coupled to the RAN via a network, to store service flow parameters for respective subscribers for a wireless service provider associated with the broadband wireless network system; and
a plurality of base stations (BS), each communicatively coupled to the RAN, each BS comprising facilities to support communications via a broadband wireless network protocol and perform operations including:
identifying a mobile subscriber station (MSS) attempting to enter the broadband wireless network;
retrieving pre-provisioned service flow parameters corresponding to the MSS from the service flow database; and
creating service flows for the MSS based on the pre-provisioned service flow parameters that are retrieved, the service flows enabling the MSS to access the broadband wireless network via a base station.

15. The broadband wireless network system of claim 14, further comprising:
a network management system, communicatively-coupled to the RAN via a network, the network management system to manage each of the base stations using Simple Network Management Protocol (SNMP) messaging.

16. The broadband wireless network system of claim 14, further comprising:
a Management Information Base (MIB) instance hosted by each of the BSs, each MIB instance to store service flow data related to MSSs currently being served by the BS hosting that MIB instance.

17. The broadband wireless network system of claim 14, wherein each base station includes facilities to support broadband wireless communication based on the IEEE (Institute of Electronic and Electrical Engineers) P802.16-based broadband wireless standard.

18. The broadband wireless network system of claim 14, wherein a given base station can operate as a serving base station or a target base station in connection with a hand-over of an air interface between a mobile subscriber station (MSS) and a serving base station (BS) to a target BS, and a base station further includes instructions to perform operations including:
determining a condition under which a hand-over of an air interface between an MSS and a serving base station (BS) to a target BS is necessary or would be advantageous;
identifying the target BS to which to migrate the air interface;
forwarding service flow information corresponding to pre-provisioned service flows for the MSS from the serving BS to the target BS;
pre-provisioning service flows for the air interface between the MSS and the target BS in view of the service flow information that was forwarded; and
providing service flows to the MSS via the target BS based on the pre-provisioned service flows.

19. The broadband wireless network system of claim 18, wherein a base station further includes facilities to perform operations including:
passing information from the serving BS to the target BS identifying operational parameters currently employed to support the air interface between the MSS and the serving BS;
determining if the target BS can support the same operational parameters, and if so,
creating service flows for the migrated air interface between the MSS and the target BS using the same operational parameters; otherwise,
determining a different set of operational parameters that may be supported by the target BS; and
creating service flows for the migrated air interface using the different set of operational parameters.

20. The broadband wireless network system of claim 18, wherein a base station further includes facilities to perform operations including:
storing respective sub-sets of the subscriber service flow provisioning information in Management Information Base (MIB) instances at the serving BS and the target BS;
storing pre-provisioned service flows for the MSS in the MIB instance at the serving BS; and, in response to initiation of a hand-over,
generating an MIB sub-tree structure containing the pre-provisioned service flows for the MSS;
sending the MIB sub-tree structure from the serving BS to the target BS;
extracting the pre-provisioned service flows from the MIB sub-tree structure; and
inserting information corresponding to the pre-provisioned service flows into the MIB instance at the target BS to pre-provision the service flows.
